(19) United States
(12) Patent Application Publication
(10) Pub. No.: US 2003/0151775 A1
(43) Pub. Date: Aug. 14, 2003

(54) Method and system for tracking a photoconductor belt loop in an image forming apparatus

(75) Inventors: Bobo Wang, Palos Verdes Estates, CA (US); Sheng-Jenq Chang, HsinChu (TW); Chun-Chiang Chen, Fengshan City (TW)

Correspondence Address: LEE & HONG, 801 SOUTH FIQUEROA STREET, 14TH FLOOR, LOS ANGELES, CA, 90017, US

(73) Assignee: Aetas Technology Inc.

(21) Appl. No.: 10/224,634

(22) Filed: Aug. 20, 2002

Related U.S. Application Data
(60) Provisional application No. 60/356,624, filed on Feb. 13, 2002.

(51) Int. Cl. G06F 15/00; B41B 1/00; H04N 1/29

(52) U.S. Cl. 358/300; 358/1.8

(57) ABSTRACT

The present invention is directed to a method and system for tracking a photoconductor belt loop in an image forming apparatus that effectively monitors and compensates for changes in the OPC belt's speed and position as well as for possible contamination of the code strip and damage to the photo sensors. There is provided a method and system for sensing a code strip on the photoconductor belt loop with a first sensor, producing a first signal, sensing a code strip on the photoconductor belt loop with a second sensor, producing a second signal, computing a phase shift error between the first and second signals; and synchronizing first and second signals.

### CROSS REFERENCE TO RELATED APPLICATION

Pursuant to 35 U.S.C. §119(e), this application claims the benefit of earlier filing date to U.S. Provisional Patent Application No. 60/356,624, filed on Feb. 13, 2002, entitled “Method For Tracking A Photoconductor Belt Loop In An Imaging System,” the content of which is hereby incorporated by reference in its entirety.

### BACKGROUND OF THE INVENTION

1. Field of the Invention

The present invention relates to an image forming system used for electrophotographic systems, and more particularly, an image forming system that senses the relative position and velocity of a moving organic photoconductor (OPC) within the image forming apparatus.

2. Description of the Related Art

Non-impact printing involves the use of an image carrying member (e.g. OPC member) that is initially charged to a substantially uniform potential. Non-impact printing is carried out through several different processes, including ink jet, toner jet, electrophotographic imaging (“EPG”), liquid toner, direct imaging, and other non-impact printing methods. While the present application applies to any non-impact printing method, the following description will use the EPG method and system by way of an example. Any references to an EPG method or system shall be construed to apply equivalently to any non-impact printing method or system. An electrostatic latent image is formed on the surface of the OPC belt, usually by way of a light source, which discharges the charged OPC belt in selected areas. The latent image is then transferred by bringing a developer material, typically a toner, into contact with the OPC surface. The completed image is then transferred to a recording sheet (e.g. paper sheet, transparency sheet) and permanently affixed thereto by fusing with applied heat and pressure.

In multicolor printing, a plurality of images are formed and transferred onto the OPC belt. Typically, a four-color image requires a separate image for each of the four colors (e.g. cyan, magenta, yellow, and black) which are transferred onto the OPC belt and superimposed to form a single image.

An OPC belt containing a color image in an EPG imaging system basically is a grid of pixels whose size, color, and spatial relationship create an illusion of a single complete image. A pixel is a point on the latent image on the OPC surface, exposed by a light source (e.g. light emitting diode, “LED,” liquid crystal display array, “LCD,” or other fixed optical source). In this regard, each pixel represents a particular color that contributes to the visual aspects of the color image. To create the desired color, each pixel may be superimposed upon other pixels of the same or different corresponding color. Upon development, several very small colored plastic particles adhere to the corresponding pixel locations. These colored particles, known as toner particles, are fused so as to blend and adhere to the recording sheet to complete the image creation.

To achieve printing of all the colors of the rainbow in a color image, an EPG imaging system may employ four-color print stations that use toner particles having a cyan, magenta, yellow, or black color. For example, under the cyan, magenta, yellow, or black (CMYK) subtractive color system, magenta and yellow make red, cyan and magenta make blue, and cyan and yellow make green.

To make a green dot, for example, a cyan toner particle may be transferred from a first print station onto a pixel on an electrostatically charged OPC belt. The OPC belt then may be rotated so as to position the cyan toner particle underneath the second print station having yellow toner particles. A yellow toner particle may then be transferred from the second print station onto, or near, the cyan toner particle. Stacking of one toner particle on top of another toner particle may be referred to as a “tone-on-tone” or an “image-on-image” process. Depending on the imaging needs, a toner particle may be stacked entirely on top of a previously transferred toner particle, or the toner particle may lie on top of only a portion of the previously transferred toner particle. The stack then may be transferred to a recording sheet where the stack is fused to form a green dot.

One of the difficulties encountered in transferring a multi-color image to an OPC belt is belt tracking. In multi-pass color printing, one color is imaged and transferred to the OPC belt, where it rotates one full cycle before the next color is imaged and transferred. Thus, the OPC belt makes multiple passes before transferring a given multi-color image to a recording sheet.

Imaging devices require that the image transferred to the OPC be registered accurately with the image light source. Both single and multi-pass color printing require precise control of the OPC belt and its interaction with the imaging, developing, and transfer stations of the printing apparatus for the correct registration between the color images and to avoid any image degradation. Tone-on-tone imaging devices require accurate registration to correctly superimpose color images. The OPC belt's motion must be accurately controlled, especially in the span of the belt that encompasses the imaging and developing stations. The average toner particle diameter is between about 8 to about 15 micrometers. The positional accuracy required for acceptable registration in the trade is typically below a maximum limit of 125 micrometers. Some imaging techniques require registration inaccuracy of no more than about 30 micrometers between color images for pictorial information.

Encoder strips or “code strips” are used in image-related devices such as printer/plotters, scanners, facsimile machines and the like. Imaging devices require that the image transferred onto the OPC be registered accurately with the image light source. A code strip helps establish the position of a marking or sensing device mounted for exposing across a printing medium on which an image is to be printed, or from which an image is to be read.

A code strip is a graduated strip, generally disposed across an area where the medium is held, and having gradations that can be automatically sensed. Historically code strips have been made of polymer material with fiduciary markings formed photographically. For optimum performance, the code strip's fiduciary markings should be very close to both a light source and a detector used as parts of a sensing system for reading the fiduciary markings.

The use of a code strip and a corresponding detector can perform the operation of monitoring the position and velocity of an image forming belt only to a certain degree. FIGS. 1A and 1B illustrate a typical multi-color image forming system according to prior art utilizing a code strip or “encoder” (denoted by “encoder length) located on the OPC belt. The corresponding detector for the encoder is the photo sensor Ps.

FIG. 2 illustrates a portion of a typical OPC belt according to prior art. Generally, a seam 304 may result from splicing together the opposing ends of the OPC belt to form a looped configuration joined by the seam 304. The seam 304 defines a location known as the home position. The code strip 306 may include an end 408 and an end 410 so that the seam 304 is disposed between the end 408 and the end 410.

For the configuration as shown in FIGS. 1A and 1B, the entire belt loop track needs to be continuously detectable in order to continuously track belt motion and also to increase the printing throughput. However, due to the existence of the seam of the belt and the manufacture process of applying the code strip on the belt, the code strip cannot be mounted on the belt in a complete loop. As a result, when the seam area of the OPC belt, with no code strip on it, passes through Ps, as depicted in FIG. 1B, the sensor will not be able to detect any displacement variation. Consequently, the detector cannot continue providing the feedback signal to the exposure units to form the image synchronously on OPC belt. Therefore, the configuration of code strip detection in FIGS. 1A and 1B with only one sensor or detector on it cannot achieve continuous displacement detection of the OPC belt moving.

Further disadvantages in the use of a single sensor or detector can be seen when a belt exhibits non-uniform motion in directions transverse, diagonal, or at an angle from the belt travel path. Also, should the code strip become contaminated with toner or other debris, it is likely that errors will result in belt tracking and, ultimately, printing output. Thus, a need exists for a belt motion monitoring arrangement that monitors changes in the OPC belt's speed and position, for possible contamination or damage to the encoder, and possible damage or misalignment of the photo sensor.

### SUMMARY OF THE INVENTION

Accordingly, the present invention is directed to a method and system for tracking a photoconductor belt loop in an image forming apparatus that substantially obviates one or more of the problems due to limitations and disadvantages of the related art. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for continuously tracking the motion of a photoconductor belt loop in an image forming apparatus comprises the steps of sensing a code strip on the photoconductor belt loop with a first sensor, producing a first signal; sensing a code strip on the photoconductor belt loop with a second sensor, producing a second signal; computing a phase shift error between the first and second signals; and synchronizing signal outputs of the first and second sensors.

According to one aspect of this embodiment, the above-described method further comprises the steps of designating the first sensor as primary to sense the code strip on the photoconductor belt loop, switching to the second sensor as primary to sense the code strip prior to when the first sensor cannot sense the code strip, and processing the phase shift prior to when the second sensor cannot sense the code strip.

A system for tracking the motion of a photoconductor belt loop in an image forming apparatus, according to one aspect of an embodiment of this invention, comprises a first sensor having a first signal output, a means for converting the first signal output to provide position information of the photoconductor belt loop, a second sensor having a second signal output, and means for converting the second signal output to provide position information of the photoconductor belt loop, synchronizing first and second signal outputs, and comparing first and second signal outputs with one or more programmed parameters.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1A illustrates a diagram of an electrophotographic printing apparatus with an image forming member employing an encoder detected by a photo sensor in accordance with prior art;

FIG. 1B illustrates a diagram of an electrophotographic printing apparatus with an image forming member employing an encoder not detected by a photo sensor in accordance with prior art;

FIG. 2 illustrates an OPC belt having a seam and containing a code strip along the length of the belt except the area occupied by the seam, in accordance with prior art;

FIG. 3 illustrates a schematic diagram illustrating an electrophotographic printing apparatus according to one or more embodiments of the present invention;

FIG. 4 illustrates a photo sensor and detector module as seen along line 1A-1A in FIG. 3;

FIG. 5A illustrates a diagram of an electrophotographic apparatus with an image forming member employing an encoder detected by the first of two photo sensors in accordance with one or more embodiments of the present invention;

FIG. 5B illustrates a diagram of an electrophotographic apparatus with an image forming member employing an encoder detected by the second of two photo sensors in accordance with one or more embodiments of the present invention;

FIG. 6A illustrates a schematic diagram exemplifying a code strip detected by two misaligned sensors in accordance with one or more embodiments of the present invention;

FIG. 6B illustrates a diagram exemplifying contaminated code strip in accordance with one or more embodiments of the present invention;

FIG. 6C illustrates a graphic representation of a shift in phase of signals of a pair of encoder detecting photo sensors in accordance with one or more embodiments of the present invention; and

FIG. 7 illustrates an internal block diagram of a system for tracking a photoconductor belt loop in an image forming apparatus according to one or more embodiments of the present invention.

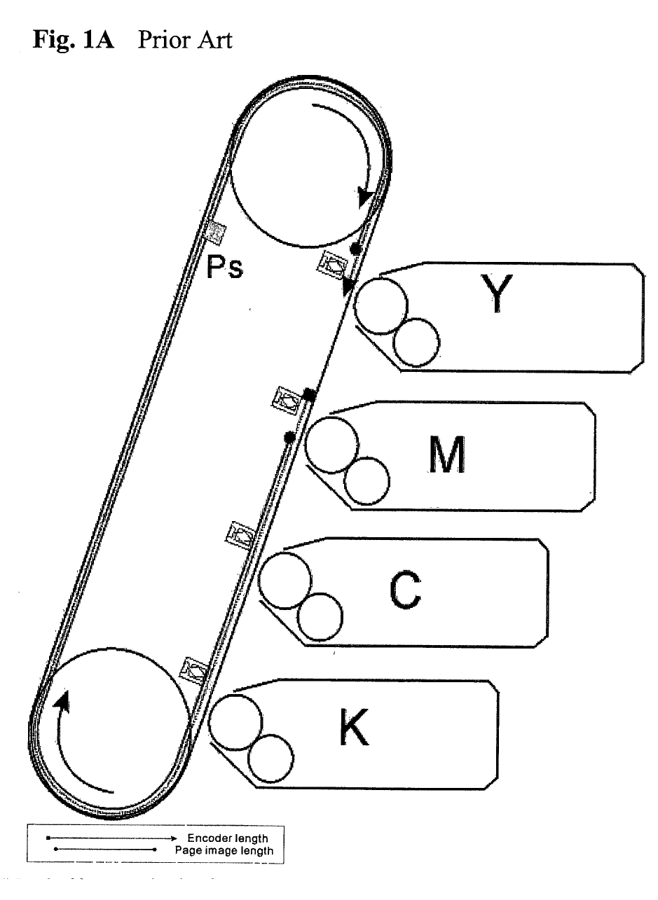

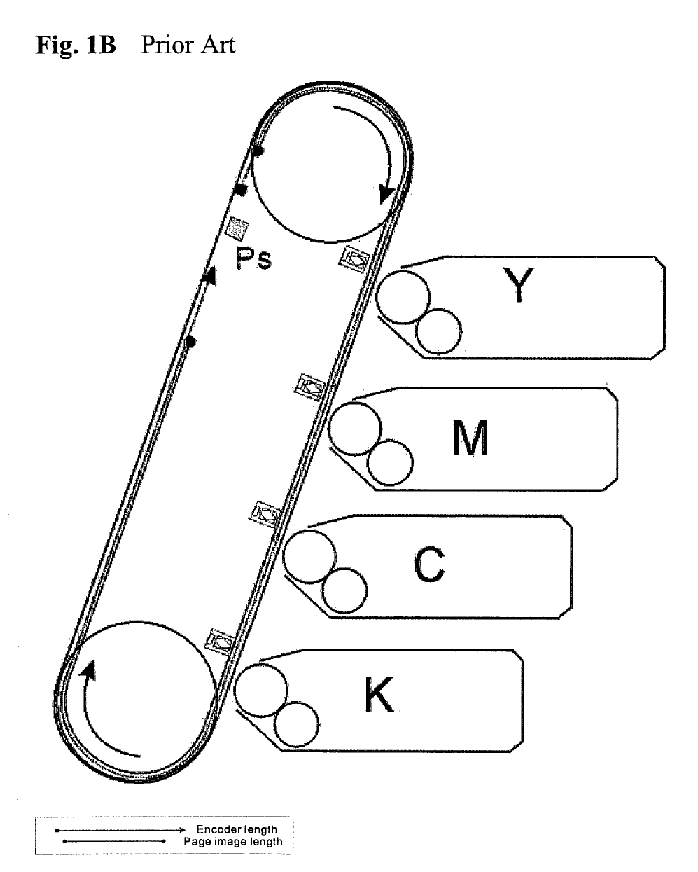

Features, elements, and aspects of the invention that are referenced by the same numerals in different figures represent the same, equivalent, or similar features, elements, or aspects in accordance with one or more embodiments.

Reference will now be made in detail to one or more embodiments of the invention, examples of which are illustrated in the accompanying drawings.

### DETAILED DESCRIPTION OF THE PREFERRED EMBODIMENTS

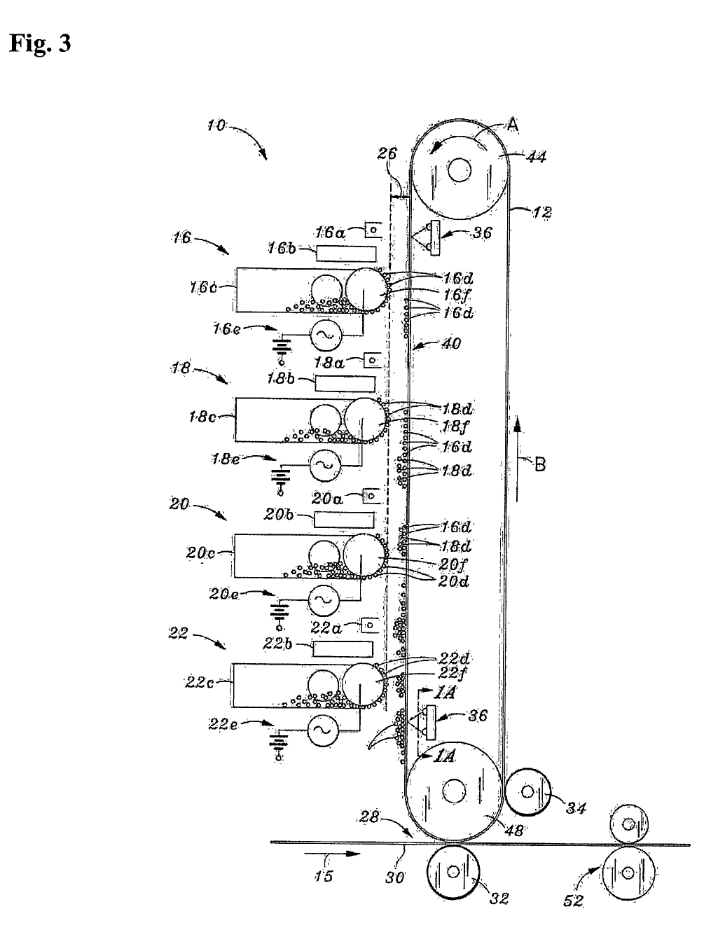

FIG. 3 illustrates an EPG printing apparatus 10 suitable for practicing an embodiment of the present invention. This particular arrangement illustrates a discharge area development (DAD) printing technique. It will be recognized that the advantages of the present invention will apply to other EPG techniques, and any other apparatus that incorporates a moving belt.

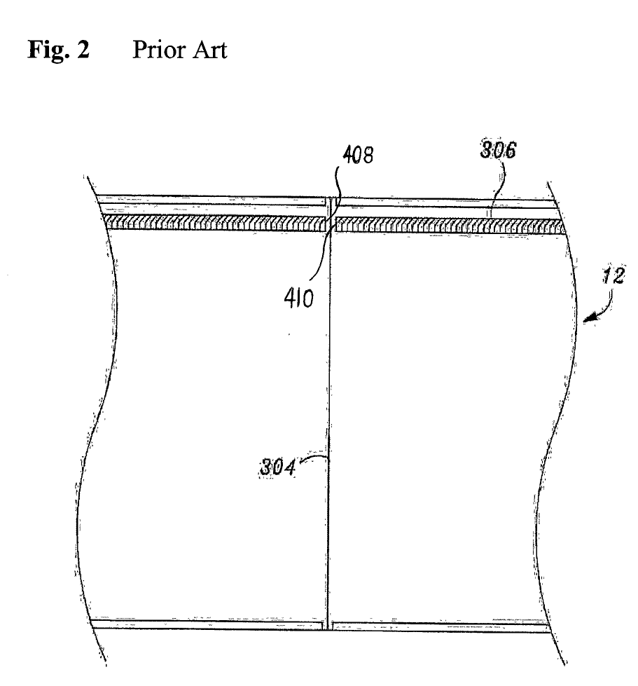

An OPC belt 12 is entrained around an idle roller 44 and a drive roller 48, which is coupled to a motor (not shown). The outside surface of belt 12 contains a charge retentive material. Similar to the OPC belt in FIG. 2, the belt 12 may include a seam and a code strip, which is secured to the OPC belt 12 and acts with a light source to measure the exact location of the belt. Preferably, the code strip of the OPC belt 12 is a polymer strip with fiduciary markings, as illustrated in U.S. patent application Ser. No. 09/892,425, the disclosure of which is incorporated herein by reference.

The OPC belt 12 travels in direction of arrow B, the process direction, and encounters the first of a pair of photo sensors 36, the operation of which is described below. A corona charge device 16a is then encountered, where the charge retentive surface is charged to a uniform potential. The belt surface is then exposed to a latent image at imaging station 16b, which is a light source that may include, for example, a light emitting diode (LED) array. The latent image is formed as the LED array scans across the moving belt 12 to expose and discharge selected areas of belt 12. In a typical EPG process, the discharged areas correspond to text or imaged areas on the original document.

The latent image is transferred as the selectively discharged areas of the belt 12 move past developing device 16c, which typically provides black toner to the discharged areas. The belt then moves past a second charge device 18a and a second light source 18b to provide a second latent image on belt 12. The second latent image is superimposed onto the black image previously transferred onto the belt and toner is transferred from developing device 18c with a first color toner, e.g. yellow. In a similar manner, third and fourth charge and development stations provide respective latent images in two other colors, usually magenta, and cyan, respectively. The OPC belt 12 is thus provided with a multi-color image as it passes over the second of a pair of photo sensors 36. The multi-color image is then transferred to a recording sheet 30, e.g., a blank sheet of paper, which is conveyed in contact with belt 12 in the direction of arrow 15 at transfer station 28. A fuser assembly 52 applies heat to fuse the toner particles onto the recording sheet.

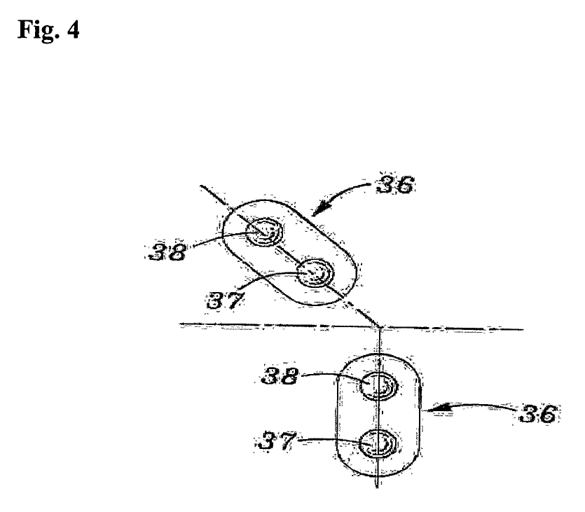

The code strip is attached or printed to the OPC belt surface. FIG. 4 illustrates one of a pair of photo sensors 36. A light source 37 illuminates the fiduciary markings. A light detector 38, adjacent to the code strip and in a position to detect light reflected from the code strip, detects the individual light signals corresponding to the movement of belt 12. The light detector 38 produces an electric signal that is conveyed to a controller (not shown), which determines the precise time to actuate the individual light sources such as 16b, 18b, 20b, and 22b to selectively discharge areas of the OPC belt 12. Control signals are provided to light sources and to second, third, and fourth charge, development, and erase stations.

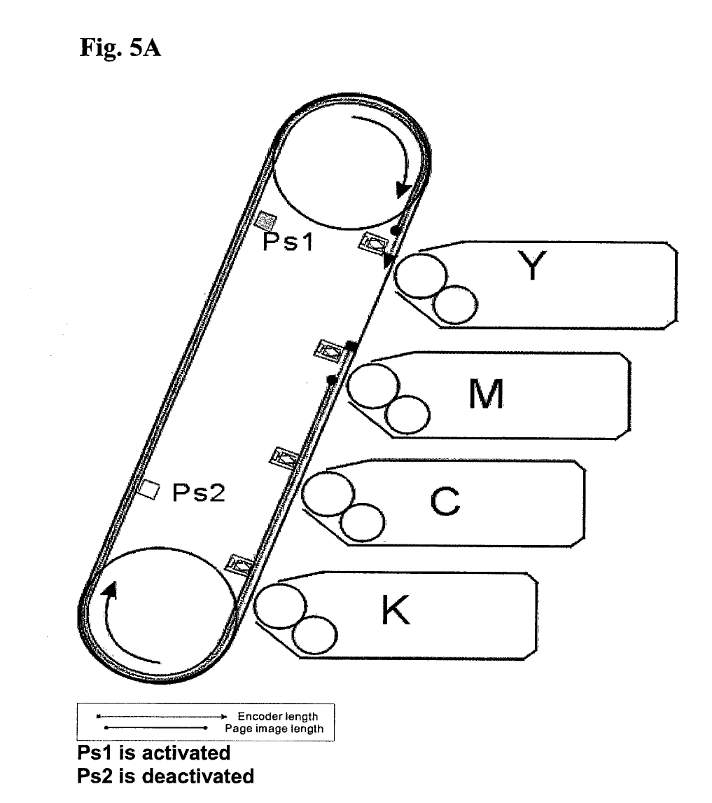

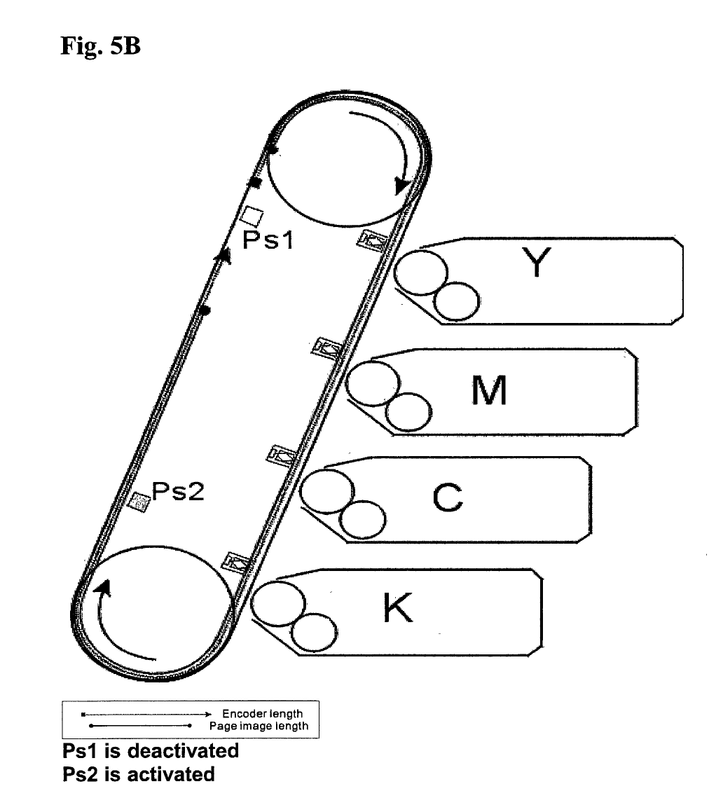

FIGS. 5A and 5B illustrate the advantages over prior art in the utilization of two photo sensors. The present invention, an embodiment of which is shown in FIG. 4A and FIG. 4B, provides an additional sensor Ps2 at a distance from the first sensor Ps1. Referring to FIG. 4A, which illustrates for example a one-pass color printing machine, first sensor Ps1 is activated to detect displacement variation of the OPC belt and its feedback signal is used to synchronize exposure units to form images on the OPC belt. When the seam area of the OPC belt approaches Ps1, and the image forming process through those four exposure units is not yet completed, as shown in FIG. 4B, the present invention will then activate Ps2 to continuously track movement of the OPC belt. Therefore this present invention can overcome the foregoing problem by switching these two sensors in turn and continuously track the OPC belt loop anytime without the effect of the seam portion of the belt, such as loss of signal.

In creating a reference or zero point to begin tracking the OPC belt in an image forming system, a home function is implemented based on the geometric constraint of belt loop. When Ps1 is focused on the seam zone as shown in FIG. 4B, Ps2 is certainly focused on the code strip or non-seam zone. Under this situation, Ps1 cannot read the code strip pattern and its output will not change state; in contrast, the signal generated by Ps2 will still keep its normal pulse output. Comparing the output signals of Ps1 with encoder Ps2, it can be determined whether the Ps1 has entered into the seam zone or not. When Ps1 recovers its normal pulse output after entering the seam zone, we can distinguish that Ps1 is reading the edge of code strip pattern. This position is defined as the reference point, and a belt position recorder is reset to zero at this position.

With respect to Y-direction displacement direction of the OPC belt, which corresponds to the B direction in FIG. 3 that the OPC belt 12 travels, the pair of sensors and detectors 36 can either relay signals to the light sources (e.g., 16b) or to the motor controller driving the OPC belt 12. As with most sensing and detecting means, each of the pair of sensors and detectors 36 retain its own characteristics, e.g., pulse width error and phase error in transmitting signals. Such individual characteristics may affect the accuracy of displacement detection. For unifying the accuracy of the sensors and detectors, software and/or firmware programming may be implemented.

For example, when the seam in the OPC belt in FIG. 5B travels past Ps1, Ps1 will become the dominant encoder. Subsequently, when the seam in the OPC belt has completed one half of a revolution, the dominant encoder will switch to Ps2. Since it is very difficult to have the same phase angle of the output signals for both Ps1 and Ps2, phase shift processing is performed prior to switching from one dominant encoder to another in order to obtain a uniform encoder signal for entire belt loop when switching the two encoder signals. This switch position scheme ensures that the encoders or photo sensor and detectors can provide complete displacement information for the entire OPC belt loop.

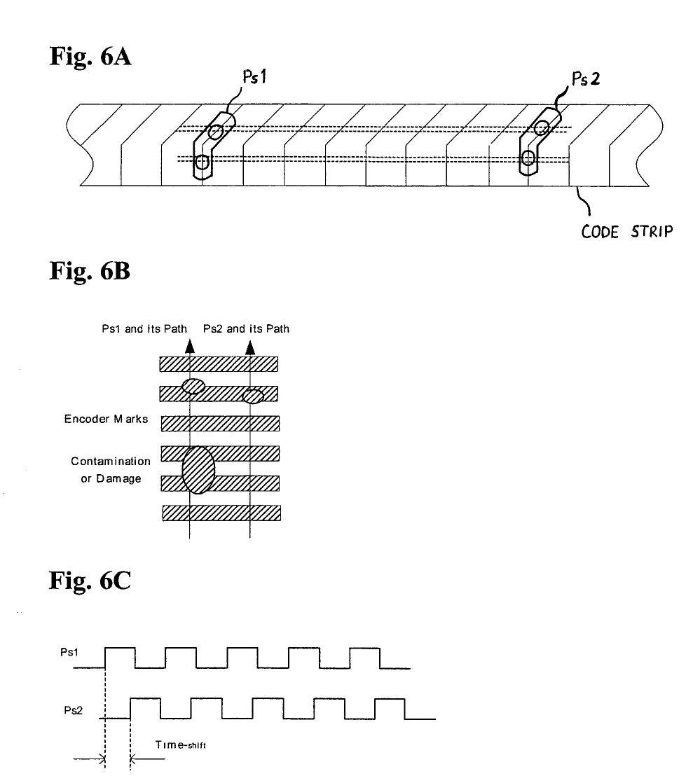

The present invention provides continuous tracking of the OPC belt loop and can compensate for non-uniform movement of the belt. Processing two photo-sensors in turn can continuously provide the absolute position data of the OPC belt. This absolute position data is very helpful for precise multicolor printing, especially if one or both sensors are misaligned, such as that shown in FIG. 6A. Additionally, an advantage exists in that if there is contamination of, debris upon, or damage to the code strip in certain areas as shown in FIG. 6B, the damaging effects can be avoided by temporarily utilizing only the sensor-detector arrangement that is operating correctly and outputting appropriate signals.

With respect to Y-direction displacement direction of the OPC belt, which corresponds to the B direction in FIG. 3 that the OPC belt 12 travels, the pair of sensors and detectors 36 can either relay signals to the light sources (e.g., 16b) or to the motor controller driving the OPC belt 12. As with most sensing and detecting means, each of the pair of sensors and detectors 36 retain its own characteristics, e.g., pulse width error and phase error in transmitting signals. Such individual characteristics may affect the accuracy of displacement detection. For unifying the accuracy of the sensors and detectors, software and/or firmware programming may be implemented.

The detected code strip signals of these two sensors will always exhibit a time shift between them due to mounting deviation. This can easily be solved by finding the shift time and compensating the sensor signals to synchronize these two signals, as shown in FIG. 6C, which will be performed in firmware or hardware control. Therefore it will still keep a steady waveform of the code strip signal to maintain belt tracking during the process of switching these two sensors in turn.

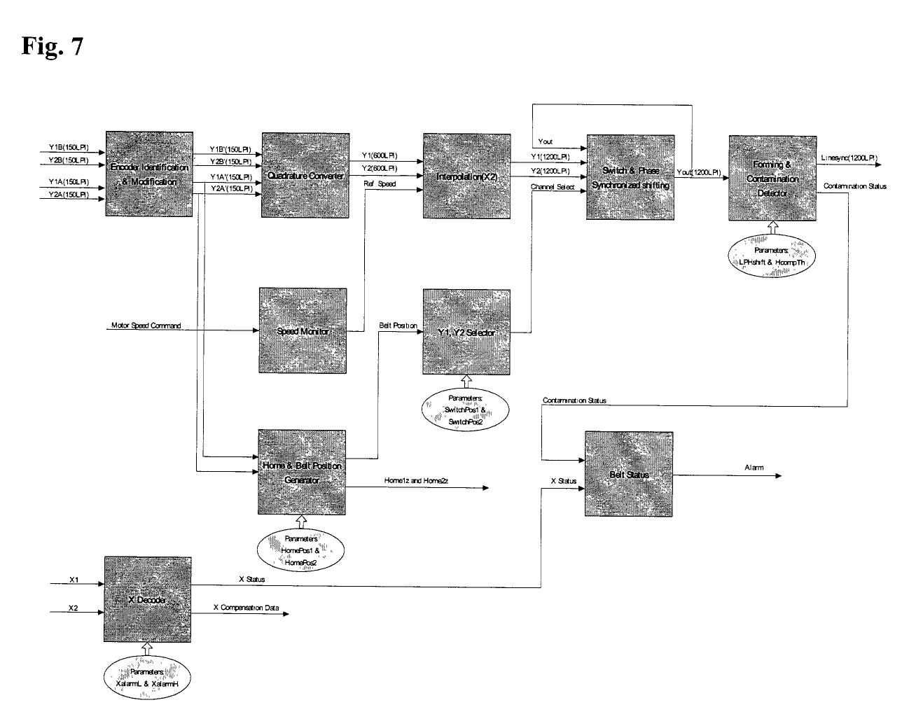

FIG. 7 illustrates an internal block diagram of a system for tracking a photoconductor belt loop in an image forming apparatus according to one or more embodiments of the present invention. For example, readings are taken at points A and B from the two photo sensors Y1 and Y2, resulting in four readings: Y1A, Y2A, Y1B, and Y2B. These signals are then identified according to sensor and printer engine parameters, for example, and modified. These signals may also be used to determine reference or home positions for the photoconductor belt. The four modified signals (now Y1A′, Y2A′, Y1B′, and Y2B′) can then be converted to two signals (Y1 and Y2) and compared with a reference speed of the photoconductor belt loop. This reference speed may be programmed or can be obtained from a separate speed monitor as shown. The signals can then be interpolated.

In addition to having both sensors monitor the belt, each sensor can be designated as a primary sensor while the seam of the belt is to be detected by the other, non-primary sensor. Once the non-primary sensor begins detecting the encoder or code strip, it is switched as the primary sensor while the previously primary sensor reverts to being the non-primary sensor. Accordingly, in FIG. 7, the process of switching can be incorporated with the two signals. By selecting the proper channel (determined by the location of the seam with respect to both sensors), the two signals can be synchronized with respect to phase shift, resulting in a dominant or primary sensor. The non-primary sensor, labeled as Y out in FIG. 7, is reverted and used for processing and synchronizing the next signals. The dominant signal can also be used to check for contamination. Previously programmed time values for signals phase shifts can be used for comparison and would result in a contamination status. This contamination status may, along with other conditions detected by the sensors, such as lateral motion, be used to notify user of belt status should operating parameters be exceeded. Such parameters can be downloaded from firmware, for initial configuration, to Application Specific Integrated Circuits (ASICs). Therefore, flexibility for applications on different kinds of printer engines can be increased.

The invention has been described with reference to the preferred embodiments. Obviously, modifications and alterations will occur to others upon a reading and understanding of the specification. For example, the concept of the present invention is also applicable to printing techniques involving more than four-color printing and to the retrofit of existing apparatus. Therefore, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for continuously tracking the motion of a photoconductor belt loop in an image forming apparatus comprising:
sensing a code strip on the photoconductor belt loop with a first sensor, producing a first signal;
sensing a code strip on the photoconductor belt loop with a second sensor, producing a second signal;
computing a phase shift error between the first and second signals; and
synchronizing first and second signals.

2. The method of claim 1, further comprising:
designating the first sensor as primary to sense the code strip on the photoconductor belt loop;
switching to the second sensor as primary to sense the code strip prior to when the first sensor cannot sense the code strip; and
processing the phase shift while the second sensor is designated as primary.

3. The method of claim 2, further comprising:
comparing first and second signals with one or more programmed parameters.

4. The method of claim 1, further comprising:
comparing first and second signals with one or more programmed parameters.

5. The method of claim 1, wherein the first and second sensors are located at predetermined positions adjacent to the photoconductor belt loop.

6. A system for tracking the motion of a photoconductor belt loop in an image forming apparatus comprises:
a first sensor having a first signal output;
a means for converting the first signal output to provide position information of the photoconductor belt loop;
a second sensor having a second signal output;
a means for converting the second signal output to provide position information of the photoconductor belt loop;
a means for synchronizing first and second signal outputs; and
a means for comparing first and second signal outputs with one or more programmed parameters.

7. A system for tracking the motion of a photoconductor belt loop in an image forming apparatus comprises:
a first sensor having a first signal output;
a second sensor having a second signal output;
a signal converter for processing the first and second signal outputs to provide position information of the photoconductor belt loop;
a signal processor for synchronizing first and second signal outputs; and
a signal controller for comparing first and second signal outputs with one or more programmed parameters.
